(19) United States
(12) Patent Application Publication
(10) Pub. No.: US 2008/0316138 A1
(43) Pub. Date: Dec. 25, 2008

(54) BALANCE-FED HELICAL ANTENNA

(75) Inventor: Behzad Tavassoli Hozouri, Santa Clara, CA (US)

Correspondence Address: Patent Venture Group, 10788 Civic Center Drive, Suite 215, Rancho Cucamonga, CA, 91730-3805, US

(73) Assignee: X-ETHER, INC., Santa Clara, CA (US)

(21) Appl. No.: 11/925,472

(22) Filed: Oct. 26, 2007

(51) Int. Cl. H01Q 1/36; H01Q 1/38; H01Q 1/50

(52) U.S. Cl. 343/859; 343/700 MS; 343/895

(57) ABSTRACT

An antenna having a cylindrical shaped dielectric core region that defines top, bottom, and side surfaces. Two laterally opposed conductive linking tracks are provided at the top or bottom surface and connect to respective groups of conductive antenna elements which extend across the top (or bottom surface) and at least partially down (or up) the side surface. A balun having two input terminals and two output terminals is provided at the top (or bottom) surface such that a feed line having two conductors extending from outside of the antenna connect respectively to the input terminals and the output terminals each connect respectively to a linking track.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Technical Field

The present invention relates generally to communications and radio wave antennas, and more particularly to balance-fed antennas.

2. Background Art

In numerous communication networks today it is required to establish communications between stations where at least one is mobile. Important requirements for antennas in such applications typically include having very wide beam coverage (ideally an omnidirectional pattern), compact structure, specific polarization type, and efficiency over a specific bandwidth. Cellular telephone handsets, satellite radio receivers, and global positional system (GPS) equipment are common examples of devices which impose such requirements. In fact, the latter usually needs an antenna meeting more strict conditions, e.g., right-hand circular polarization and a very wide beam coverage pattern encompassing nearly the entire upper hemisphere. This is needed to allow a GPS receiver to maintain signal lock with and to track as many visible satellites as possible, while also providing useful signal-to-noise and front-to-back ratios (that is, the radiation pattern has a substantially lower gain in the direction opposite to the direction of maximum gain). Another important requirement is enough isolation between an antenna and the platform to which it is attached, to minimize antenna detuning due to the presence of the platform.

One widely used option today for such applications is the patch antenna. However, these can require tradeoffs that are undesirable or unacceptable, especially in small or mobile applications. Generally, a patch antenna has a usefully low profile but this may be offset by the need for a large ground plane. A patch antenna therefore often cannot provide satisfactory performance where space is very limited. Patch antennas also do not provide good circular polarization over a very wide angular region and they tend to have poor gain at low angles of elevation, thus making them a poor choice for GPS applications. And patch antennas also do not provide a good front-to-back ratio or reasonable isolation from their environment.

Another candidate is the bifilar or quadrifilar helical antenna (BFH or QFH), particularly in printed forms. Some of the advantages of the helical antenna, particularly the QFH, are its relatively compact size (compared to other known useable antennas such as crossed dipoles), its relatively small diameter, good quality of circular polarization (suitable for satellite communication), and its having a cardioid pattern, i.e., a main forward lobe which extends over a generally hemispherical region together with a good front-to-back ratio. The size of helical antennas can also be reduced by dielectric loading or by shaping the printed linear elements.

In order to obtain good electrical performance and radiation patterns, helical antennas need to be balance-fed, i.e., two antenna feed points are subjected to signals of equal amplitude but having an 180 degree phase difference. Since the external port of such antennas are normally an unbalanced type, such as a coaxial line, a balance-to-unbalance converter (balun) is needed. Balance-feeding helical antennas also helps provide or improve isolation from the environment, particularly from antenna platforms. Normal practice is to use a balun at the bottom of the antenna, where it attaches to the platform. Balums for helical antennas are usually of either sleeve type or a PCB structure, both of which increase the total size of the antenna. Using sleeve type baluns at the bottom of helical antennas, particularly for printed helixes on a core made of material with a high dielectric constant, also adds substantially to the price and complexity of manufacturing. Another disadvantage of sleeve baluns is that they do not provide any impedance transformation, hence requiring an extra impedance matching network for such antennas.

Finally, in many communication networks antenna cost is a major concern. The cost of a suitable GPS antenna may be a trivial portion of the overall cost of an airline navigation system, but a cost-is-no-object approach is just not practical for antennas used in the communication networks that are becoming ubiquitous in our day-to-day lives. For example, in general consumer GPS, cellular telephone, and satellite radio, whether an antenna costs $0.20, $2.00, or $20.00 can be determinative of how a product is accepted in the marketplace.

Like most articles of manufacture, the cost of an antenna has two major components: the cost of the materials and the cost of fabricating those materials. It can therefore be productive here to view overall antenna suitability as having three major contributing factors. The first is antenna design, meaning whether the design provide an antenna with adequate or better performance. A number of concerns related to this have been discussed above, and will be touched on further throughout this disclosure. The second factor is the materials-cost for an antenna design. This is considered least herein, since the materials typically differ little between different designs and because antenna designers tend to be very well schooled with respect to material-costs. The third factor is the fabrication-cost of an antenna design. Some considerations here are which manufacturing technique is cheapest in terms of the machines used, the numbers and complexities of steps that these must perform, and the tolerances that equipment must be calibrated to and maintained at to achieve a desired yield. This last factor is one where much of the prior art is wanting.

### BRIEF SUMMARY OF THE INVENTION

Accordingly, it is an object of the present invention to provide improved balance-fed communication antennas.

Briefly, one preferred embodiment of the present invention is an antenna. A dielectric core region having cylindrical shape is provided. This defines top, bottom, and side surfaces. Two laterally opposed conductive linking tracks are provided at the top surface. Two groups of conductive antenna elements are also provided, wherein each includes mutually adjacent instances of at least two of the antenna elements that connect to a respective linking track. The antenna elements extend across the top surface and at least partially down the side surface. The core region has an axial passage extending from the bottom to the top surfaces and a feed line having two conductors extends from outside of the antenna through the axial passage to the top surface. A balun is provided that has two input terminals and two output terminals, wherein the input terminals each connect respectively to a feed line conductor and the output terminals each connect respectively to a linking track.

Briefly, another preferred embodiment of the present invention is also an antenna. A dielectric core region having cylindrical shape is again provided and this again defines top, bottom, and side surfaces. Two laterally opposed conductive linking tracks are provided, only here at the bottom surface. Two groups of conductive antenna elements are again provided, with each again including mutually adjacent instances of at least two antenna elements that connect to a respective linking track. Here the antenna elements instead extend across the bottom surface and at least partially up the side surface. A balun is provided that has two input terminals and two output terminals. The output terminals each connect respectively to a linking track and a feed line having two conductors extending from outside of the antenna has each conductor connecting respectively to an input terminal of the balun.

An advantage of the present invention is that it provides an antenna that is particularly suitable for mobile and handheld applications.

Another advantage of the invention is that it provides an antenna that can have a compact structure.

Another advantage of the invention is that it provides an antenna that is efficient at the frequencies of many important and emerging applications, and an antenna that is efficient across the bandwidths needed for such applications.

Another advantage of the invention is that it provides an antenna that can have suitable signal-to-noise and front-to-back ratios for many applications.

Another advantage of the invention is that it provides an antenna that can have wide beam coverage, providing near-hemispherical radiation coverage approaching an omnidirectional pattern.

Another advantage of the invention is that it provides an antenna that employs a simple feed system able to provide desired features (e.g., antenna polarization) as applications require.

Another advantage of the invention is that it provides an antenna that can have linear or circular polarization over a wide angular range (e.g., right-hand circular polarization, beam width up to about 150 degrees, and with a suitable front-to-back ratio all as typically required for GPS and satellite radio applications).

And another advantage of the invention is that it provides an antenna suitable for simple fabrication, and therefore mass production and low cost production.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended figures of drawings in which:

FIG. 1 is a perspective view of an antenna in accord with the present invention, and FIG. 2 is a cross-sectional view taken along section A-A of FIG. 1.

FIG. 3 is a schematic diagram of an equivalent circuit for a suitable impedance transformer type balun for use with the inventive antenna.

And FIG. 4 is a perspective view of an alternate antenna in accord with the present invention, and FIG. 5 is a cross-sectional view taken along section B-B of FIG. 4.

In the various figures of the drawings, like references are used to denote like or similar elements or steps.

### DETAILED DESCRIPTION OF THE INVENTION

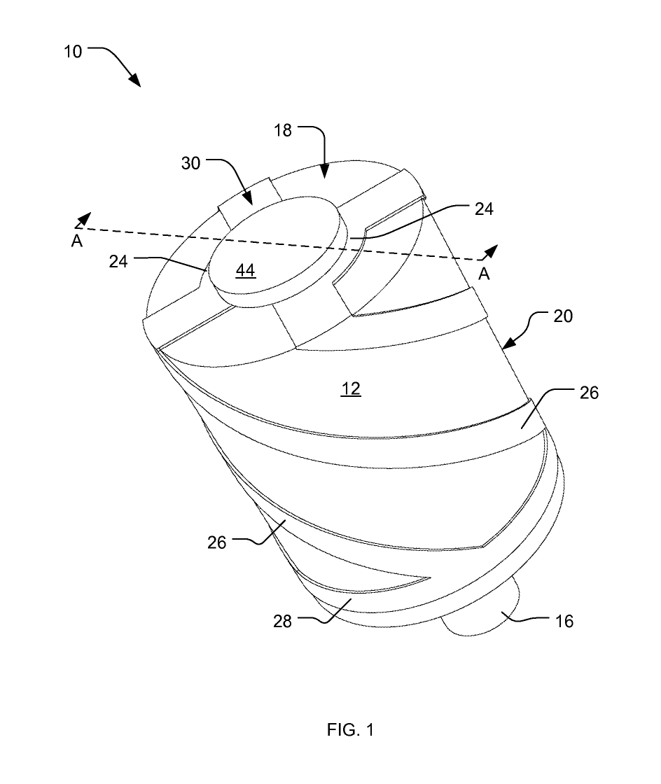

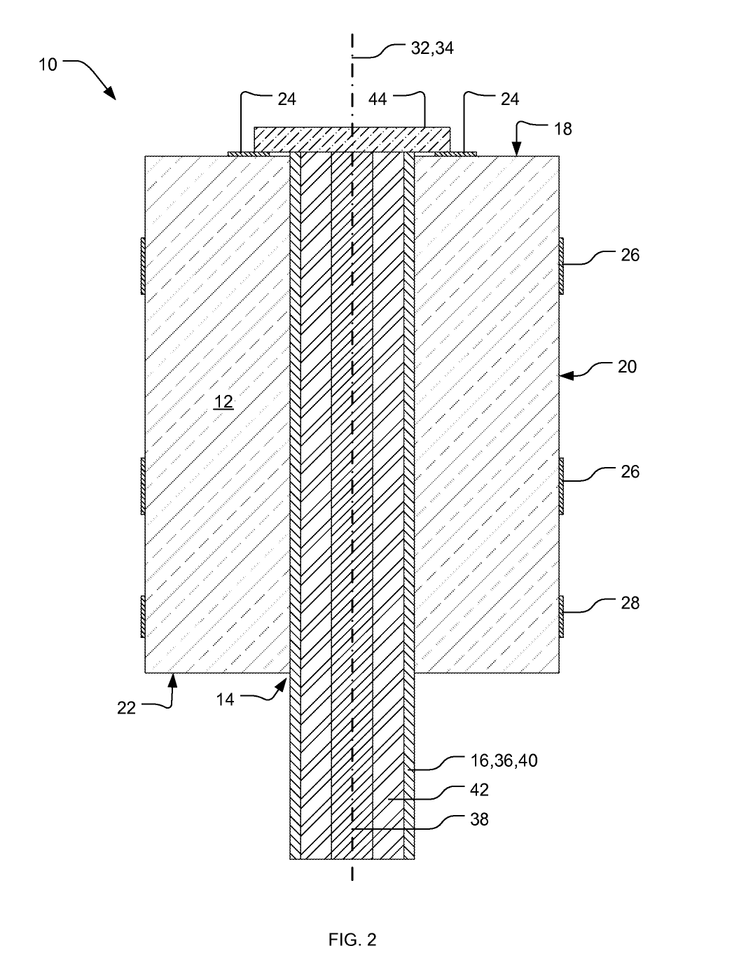

A preferred embodiment of the present invention is a balance-fed helical antenna. As illustrated in the various drawings herein, and particularly in the view of FIG. 1, preferred embodiments of the invention are depicted by the general reference character 10.

FIG. 1 is a perspective view of an antenna 10 in accord with the present invention, and FIG. 2 is a cross-sectional view taken along section A-A of FIG. 1. The antenna 10 has a nominal cylindrically shaped core region 12 with an axial passage 14 through which a feed line 16 passes.

The exterior of the core region 12 is defined as having a top surface 18, a side surface 20, and a bottom surface 22. As discussed presently, the core region 12 may simply be air, some other gas, or vacuum and the boundaries of these “surfaces” then are set by the other elements of the antenna 10.

The antenna 10 has a pair of laterally opposed conductive linking tracks 24 at the top surface 18 that each connect to a group of conductive antenna elements 26. In FIGS. 1-2, each such linking track 24 connects to a group of two mutually adjacent antenna elements 26. The antenna elements 26 extend across the top surface 18 and down the side surface 20 of the core region 12 to a single conductive track 28. As can be seen in FIG. 1, The antenna elements 26 thus extend from the one or more of the linking tracks 24 on the top surface 18 to the single conductive track 28 on the side surface 20 of the core region 12. The lengths of the antenna elements 26 are selected so they resonate at frequencies that are the same as or close to the main application frequency or frequencies of the antenna 10.

The feed line 16 passes axially through the core region 12, from the bottom surface 22 to a feeding region 30 at the top surface 18. The antenna 10 inherently has a longitudinal axis 32 and the feed line 16 can have a longitudinal axis 34 that is normally coaxial with this. As shown in FIG. 2, in most embodiments the feed line 16 can simply be a transmission line 36 having an inner conductor 38, an outer conductor 40, and a coaxial dielectric 42.

A balun 44 is provided here at the top surface 18 of the core region 12, and thus of the antenna 10, between the feed line 16 and the linking tracks 24 and antenna elements 26. The balun 44 provides a balanced feed to the antenna 10, thus permitting the overall structure to especially be quite compact. Optionally, the balun 44 can be an impedance transformer type (discussed presently)

The core region 12 is filled with or made of a dielectric material. For example, it may be of a low loss type like air, plastic, or ceramic. Of course, many other materials may also be used, with other gasses and even vacuum having already been noted. General radio frequency design principles will apply here, and the selection of a material should usually be straightforward. It should be appreciated, however, that this dielectric material can be either homogenous or inhomogeneous. For instance, an in-homogeneity can be created by providing multiple domains in the material with different dielectric constants. The dielectric material can thus be of an artificial type, say, of a material with a particularly high dielectric constant that is a blend of a true dielectric material and metal particles, inclusions, or various inserts.

[N.b., herein the terms “exterior” and “interior” are used with respect to an element's influence on the electrical characteristics of the inventive antenna 10, and not necessarily with respect to their literal physical position with respect to inactive other elements. For example, the core region 12 may actually be inside a thin layer of nonconductive material, such as foam or plastic, that acts as a protective cover or radome. To facilitate manufacture the elements of the antenna 10 also may be deposited onto a more outward base material that provides physical support yet does not substantially alter performance. Such usage of relative terminology is common in this art and, in any case, should now be clear in view of this reminder.]

The terms “radiate” and “excite” can be used to refer to the inventive antenna 10 for both transmitting and receiving signals. The electrical characteristics of the antenna 10, such as its frequency response and radiation pattern, obey the reciprocity rule. Accordingly, if the antenna 10 is configured and tuned to radiate right hand circular polarization when excited, it can absorb a right hand circular polarized signal at the same frequency in the receiving mode.

Returning now again to FIGS. 1-2, these depict an embodiment of the inventive antenna 10 that facilitates discussion of some design considerations. For example, a single antenna element 26 in each group served by a linking track 24 is enough to produce linear or mixed linear polarization. Alternately, other embodiments of the antenna 10 can provide other polarizations, as desired.

To design a circular polarized embodiment of the antenna 10 it would normally be necessary for all of the antenna elements 26 to radiate with equal amplitude but in different phases, e.g., to provide a progressive 90-degree phase shift between each two adjacent antenna elements 26. However, a prior art approach that can be extended to the inventive antenna 10 to provide the abovementioned condition is to differentiate the lengths of each pair of adjacent antenna elements 26 by a specific amount. The slightly different lengths of the antenna elements 26 then cause them to resonate at different frequencies, with the phase of each varying with respect to the actual frequency present. By appropriately tuning the lengths of the antenna elements 26, a fixed phase offset for each can be obtained and a predetermined total phase difference equal to the required value can be provided at a desired specific frequency, i.e., the main application frequency of the antenna 10. Such dual-resonance techniques for creating circular polarization are relatively simple and help make circular polarized embodiments of the antenna 10 cheaper to manufacture. This can also permit embodiments of the antenna 10 to create circular polarization over a very large angular region (e.g., about +/−50 degrees in both planes).

As is known in the art, double resonance methods of creating circular polarization generally produce relatively narrow bandwidths. In contrast, the inventive antenna 10 here can be designed to have a fairly low VSWR over a wider bandwidth. Thus it can have a mixed linear polarization in frequencies other than the circular polarization narrow bandwidth, and it therefore can be used for specialized applications, e.g., mobile applications, which need both circular polarization and mixed linear polarization albeit in different portions of their total bandwidths.

The adjacent antenna elements 26 preferably have similar shapes (as shown in FIGS. 1-2). This is not a requirement, however, and different shapes can also be used. For example, small slits can be added to or the middle parts can be narrowed in some of the antenna elements 26 to efficiently change their lengths, in order to create and fine-tune circular polarization with relatively less sensitivity to fabrication tolerances.

Many other known prior art techniques can also be applied to further improve the inventive antenna 10. For example, in order to reduce the vertical extension of the antenna 10, the antenna elements 26 can follow simple helical paths (as shown in FIGS. 1-2). Such a shape is not a requirement, however, and other shapes can also be utilized for the antenna elements 26, such as meandering or tapered forms. This can provide various benefits, with increased bandwidth and reduced size being two common ones.

Another technique that can be extended to the inventive antenna 10 is to fill or make the core region 12 of a low loss plastic or ceramic material with a high dielectric constant, to improve the mechanical stability and/or reduce the size of such an antenna 10 compared to that of one with air as the dielectric. Using a material with a high dielectric constant, e.g., more than 10, helps constrain the antenna near field. The resulting antenna 10 then is highly tolerant to the proximity of people, other components and other antenna. Miniaturization of the antenna 10 also helps it to have a very sharp filtering response, hence reducing the need for additional filtering between the antenna 10 and a receiver or transmitter for many applications, e.g., GPS.

When an embodiment of the antenna 10 comprises a core region 12 of a solid dielectric, it can be made by conventional photoetching techniques. This is particularly useful for a fully dielectric loaded antenna 10 (versus a partially loaded embodiment). For example, first the cylindrical core region 12 of a dielectric material is provided. Then a metallization procedure is used to coat the top surface 18 and the side surface 20 of the core region 12. Next, portions of these metallized surfaces 18, 20 are partially removed in a predetermined pattern to produce the opposing groups of antenna elements 26.

In order to have desired performance, including radiation pattern, the balun 44 provides balanced signals to the opposing groups of antenna elements 26. This also helps to prevent common mode noise from entering a receiver through the antenna path. The balun 44 can also help to isolate the antenna 10 from a platform to which it is physically connected, thus reducing undesired coupling effects and making it much less sensitive to environmental presences (e.g., in a mobile handset from influence due to the handset being handheld). By selecting a suitable impedance transformer for the balun 44, its dimensions/discreet elements and other features can all be designed for a specific embodiment of the antenna 10. Alternatively, particularly to further improve the performance, the antenna 10 can be designed to include the effect of the balun 44 or, in the extreme case, both can be optimized/designed together.

FIGS. 1-2 depict an antenna 10 having a balun 44 at the feeding region 30 on and parallel to the top surface 18 of the core region 12, hence perpendicular to the feed line 16. The balun 44 here is of an impedance-transforming type, i.e., it transforms the impedance of the antenna 10, as seen between the two opposing group of antenna elements 26, to the feed line 16 and the equipment to which the antenna 10 is connected (e.g., typically 50 ohms).

Of course, many well-known prior art approaches can be used for designing and constructing the balun 44. For instance, the balun 44 can be embodied completely or partially in a generally multilayer printed circuit boards. Unlike well-known prior art approaches, however, the balun 44 here is preferably, but not necessarily, placed at the feeding region 30 on the top surface 18 of the core region 12.

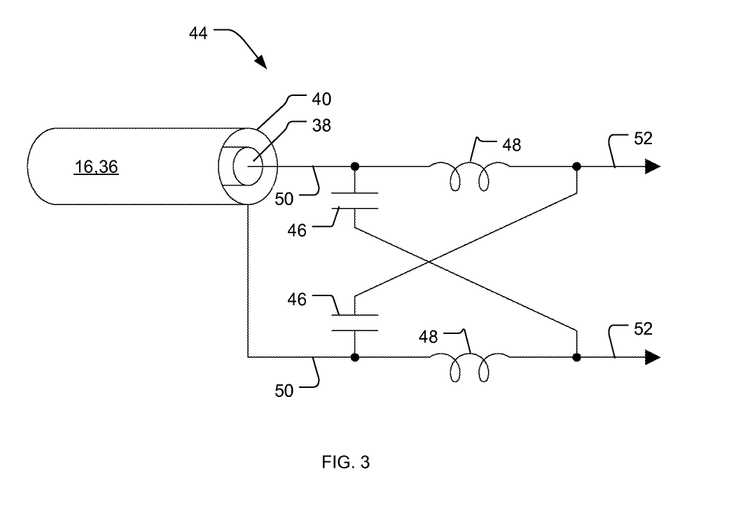

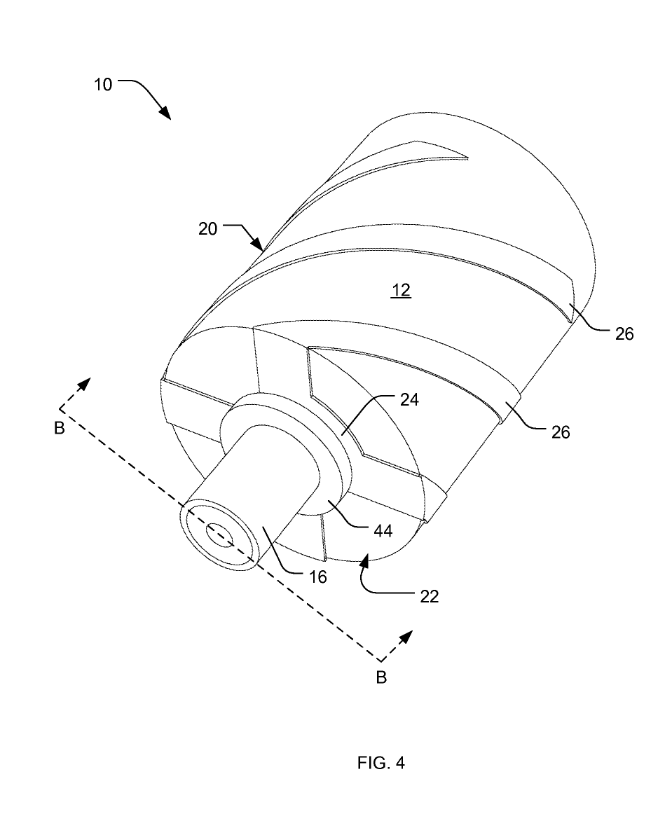

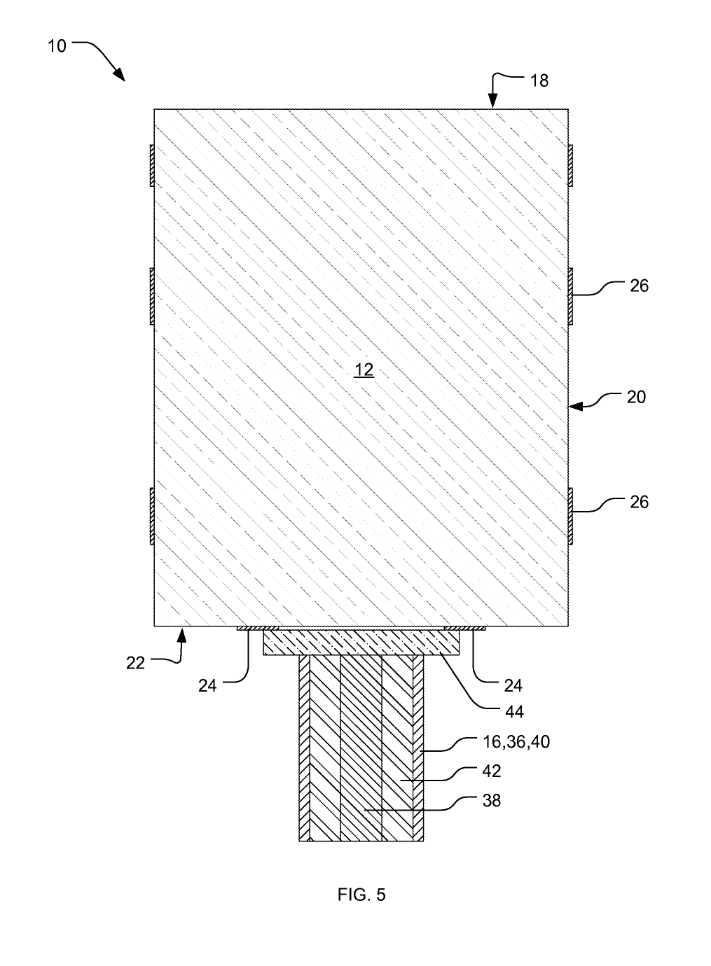

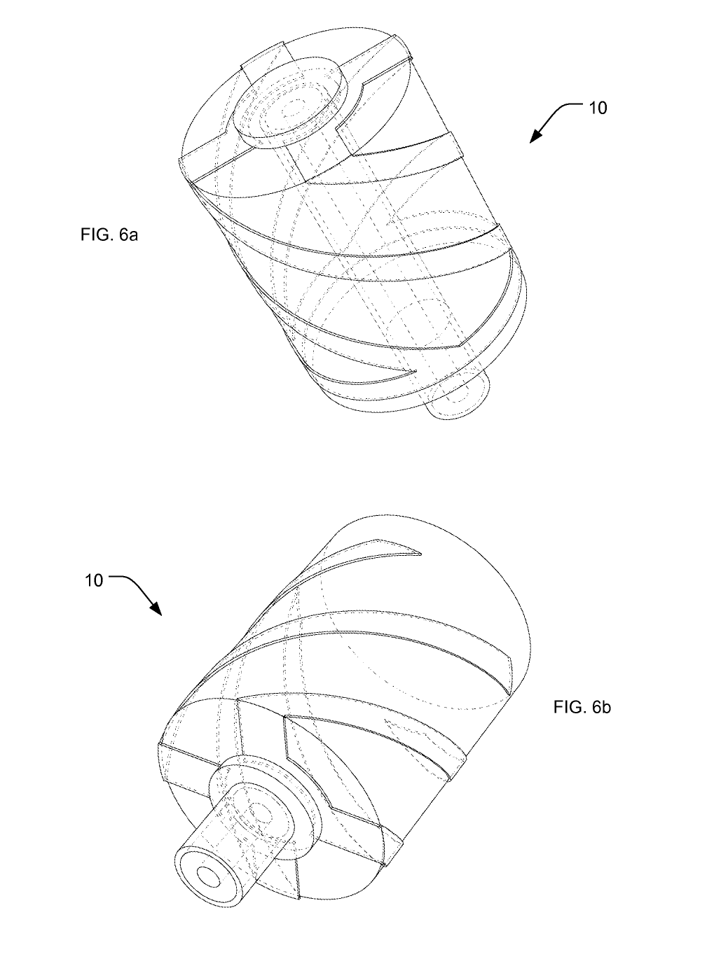

FIG. 3 is a schematic diagram of an equivalent circuit for a suitable impedance transformer type balun 44 for use with the inventive antenna 10. This balun 44 is basically a conventional lattice-type L-C balun that consists of two capacitors 46 and two inductors 48, which produce the ±90 degree phase shifts desired to balance-feed the antenna 10. The capacitors 46 and inductors 48 may, either or both, be discrete components or may be embodied as electrically conductive tracks and traces, i.e., as planar transmission line technology such as a microstrip or a strip line, on or in a circuit board. Other types of impedance transformer baluns can also be used for the balun 44, e.g. an higher order lattice-balun. As shown, the balun 44 has two input terminals 50, connected to the inner conductor 38 and outer conductor 40 of the feed line 16, and the balun 44 has two output terminals 52 that connect to respective of the linking tracks 24 (FIGS. 1-2 or 4-5).

FIG. 4 is a perspective view of an alternate antenna 10 in accord with the present invention, and FIG. 5 is a cross-sectional view taken along section B-B of FIG. 4. As can be observed, an impedance transformer balun 44 is provided here at the bottom surface 22 of the core region 12 but parallel to that surface to reduce the total structural size of the antenna 10. Since the feed line 16 now only needs to extend to the bottom surface 22 here, there is no need for an axial passage through the core region 12 of the antenna 10. Of course, as discussed with respect to FIGS. 1-2, the core region 12 can also be air-filled, and thus be entirely open rather than filled with a discernable dielectric material as depicted in FIGS. 4-5.

FIGS. 4-5 also illustrate some other possible distinctions from the embodiment shown in FIGS. 1-2. The linking tracks 24 are now at the bottom surface 22 of the core region 12 and the antenna elements 26 now extend across the bottom surface 22, up the side surface 20, toward the top surface 18. The single conductive track 28 present in FIGS. 1-2 is optional, and there is no equivalent in the exemplary embodiment shown here in FIGS. 4-5.

While various embodiments have been described above, it should be understood that they have been presented by way of example only, and that the breadth and scope of the invention should not be limited by any of the above described exemplary embodiments, but should instead be defined only in accordance with the following claims and their equivalents.

What is claimed is:

1. An antenna, comprising:
a dielectric core region having cylindrical shape defining a top surface, a bottom surface, and a side surface;
two laterally opposed conductive linking tracks at said top surface;
two groups of conductive antenna elements, wherein each said group includes mutually adjacent instances of at least two said antenna elements that connect to a respective said linking track and extend across said top surface and extend at least partially down said side surface;
said core region having an axial passage extending from said bottom surface to said top surface;
a feed line having two conductors, wherein said feed line extends from outside of the antenna, through said axial passage to said top surface; and
a balun having two input terminals and two output terminals, wherein said input terminals each connect respectively to a said conductor of said feed line and said output terminals each connect respectively to a said linking track.

2. The antenna of claim 1, wherein:
said core region is filled with a solid material.

3. The antenna of claim 1, wherein:
said core region is open and thereby fill able with whatever comprises an ambient environment of the antenna.

4. The antenna of claim 1, wherein the antenna has a longitudinal axis and wherein:
at least some of said antenna elements extend down said side surface non-planar with respect to the longitudinal axis.

5. The antenna of claim 4, wherein:
said at least some of said antenna elements spirally extend down and at least partially around said side surface.

6. The antenna of claim 1, wherein said antenna elements each have a first end conductively connected to a said linking track and a second end on said side surface, and the antenna further comprises:
a conductive terminating track encircling said side surface and conductively connecting at least some said second ends of said antenna elements in each said group.

7. The antenna of claim 1, wherein:
said balun is an impedance transformer type.

8. An antenna, comprising:
a dielectric core region having cylindrical shape defining a top surface, a bottom surface, and a side surface;
two laterally opposed conductive linking tracks at said bottom surface;
two groups of conductive antenna elements, wherein each said group includes mutually adjacent instances of at least two said antenna elements that connect to a respective said linking track and extend across said bottom surface and extend at least partially up said side surface;
a balun having two input terminals and two output terminals, wherein said output terminals each connect respectively to a said linking track; and
a feed line having two conductors extending from outside of the antenna and each connecting respectively to a said input terminal of said balun.

9. The antenna of claim 8, wherein:
said core region is filled with a solid material.

10. The antenna of claim 8, wherein:
said core region is open and thereby fill able with whatever comprises an ambient environment of the antenna.

11. The antenna of claim 8, wherein the antenna has a longitudinal axis and wherein:
at least some of said antenna elements extend up said side surface non-planar with respect to the longitudinal axis.

12. The antenna of claim 11, wherein:
said at least some of said antenna elements spirally extend up and at least partially around said side surface.

13. The antenna of claim 8, wherein said antenna elements each have a first end conductively connected to a said linking track and a second end on said side surface, and the antenna further comprises:
a conductive terminating track encircling said side surface and conductively connecting at least some said second ends of said antenna elements in each said group.

14. The antenna of claim 8, wherein:
said balun is an impedance transformer type.
